(19) United States
(12) Patent Application Publication
(10) Pub. No.: US 2024/0027613 A1
(43) Pub. Date: Jan. 25, 2024

(54) OBJECT DETECTION APPARATUS AND OBJECT DETECTION METHOD

(71) Applicant: Panasonic Intellectual Property Management Co., Ltd., Osaka (JP)

(72) Inventors: Hiroto SANKODA, Kanagawa (JP); Yuichi ISHIKAWA, Hyogo (JP); Osamu SHIBATA, Hyogo (JP)

(21) Appl. No.: 18/475,564

(22) Filed: Sep. 27, 2023

Related U.S. Application Data
(63) Continuation of application No. PCT/JP2021/037433, filed on Oct. 8, 2021.

(30) Foreign Application Priority Data
Mar. 29, 2021 (JP) 2021-055814

(51) Int. Cl. G01S 15/04; G01S 7/527; G01S 7/524; G01S 15/10; G01S 15/931

(52) U.S. Cl. CPC G01S 15/04; G01S 7/527; G01S 7/524; G01S 15/10; G01S 15/931

(57) ABSTRACT

An object detection apparatus includes: measurement circuitry, which, in operation, measures a first local maximum point of a first reflected wave of an acoustic wave and a second local maximum point of a second reflected wave of the acoustic wave, where the acoustic wave is emitted from an ultrasonic sensor; and target processing circuitry, which, in operation, performs ranging of an object by assuming that the object exists in a position within an error range ½ times a distance to a position of the first local maximum point, in a case where the first local maximum point is closer than a distance within an error range twice a reverberation distance and farther than a distance within an error range of the reverberation distance and in a case where the second local maximum point is a position within an error range 3/2 times the distance to the first local maximum point.

### BACKGROUND

### Technical Field

The present disclosure relates to an object detection apparatus and an object detection method.

### Description of the Related Art

In an object detection apparatus using an ultrasonic sensor, the ultrasonic sensor performs both transmission and reception of ultrasound, and measures the distance from the ultrasonic sensor to an object by measuring the time from when ultrasound is transmitted from the ultrasonic sensor to when the ultrasound returns to the ultrasonic sensor after hitting the object.

When the ultrasonic sensor transmits ultrasound, vibration at the time of the transmission continues according to inertia for a certain time after the transmission of the ultrasound, and thus, the ultrasonic sensor keeps detecting the vibration while the vibration continues. This is called reverberation.

This reverberation makes it difficult to distinguish, for the time from when sonar transmits ultrasound to when the reverberation ends, whether a received wave is caused by the reverberation or is a reflected wave reflected by an object, and makes it difficult to detect an object that exists at a short distance.

For example, the ultrasonic object detection apparatus of Patent Literature (hereinafter referred to as “PTL”) 1 (Japanese Patent Application Laid-Open No. 2016-031354) utilizes the fact that in a case where an object exists at a short distance, a reflection waveform of the object is added to a reverberation waveform and a reverberation time until the reverberation falls below a detection threshold value is prolonged. When a measured reverberation time is longer than a reference reverberation time in a case where no object exists at a short distance, the ultrasonic object detection apparatus determines that an object exists at a short distance.

Further, even when a measured reverberation time is not longer than the reference reverberation time, this ultrasonic object detection apparatus compares, in a case where a first reflected wave is detected within a certain time and the wave reception intensity of the first reflected wave is saturated, an addition reverberation time obtained by adding the time, which elapses until the first reflected wave terminates, to the measured reverberation time with the reference reverberation time. In a case where the addition reverberation time is prolonged, the ultrasonic object detection apparatus determines that an object exists at a short distance.

### BRIEF SUMMARY

One non-limiting and exemplary embodiment facilitates providing an object detection apparatus and an object detection method each capable of detecting an object regardless of the distance from a vehicle to the object.

An object detection apparatus according to an embodiment of the present disclosure includes: measurement circuitry, which, in operation, measures a first local maximum point of a first reflected wave of an acoustic wave and a second local maximum point of a second reflected wave of the acoustic wave, where the acoustic wave is emitted from an ultrasonic sensor provided in a vehicle and the second reflected wave is a reflected wave following the first reflected wave; and target processing circuitry, which, in operation, performs ranging of an object by assuming that the object exists in a position within a predetermined error range of a distance ½ times a distance from the ultrasonic sensor to a position corresponding to the first local maximum point, in a case where the position corresponding to the first local maximum point is closer than a distance within a predetermined error range of a distance twice a reverberation distance corresponding to a reverberation duration time of the ultrasonic sensor and farther than a distance within a predetermined error range of the reverberation distance and in a case where a position corresponding to the second local maximum point is a position within a predetermined error range of a distance 3/2 times the distance from the ultrasonic sensor to the position corresponding to the first local maximum point.

An object detection method according to the embodiment of the present disclosure includes: measuring a first local maximum point of a first reflected wave of an acoustic wave and a second local maximum point of a second reflected wave of the acoustic wave, where the acoustic wave is emitted from an ultrasonic sensor provided in a vehicle and the second reflected wave is a reflected wave following the first reflected wave; and performing ranging of an object by assuming that the object exists in a position within a predetermined error range of a distance ½ times a distance from the ultrasonic sensor to a position corresponding to the first local maximum point, in a case where the position corresponding to the first local maximum point is closer than a distance within a predetermined error range of a distance twice a reverberation distance corresponding to a reverberation duration time of the ultrasonic sensor and farther than a distance within a predetermined error range of the reverberation distance and in a case where a position corresponding to the second local maximum point is a position within a predetermined error range of a distance 3/2 times the distance from the ultrasonic sensor to the position corresponding to the first local maximum point.

According to an embodiment of the present disclosure, it is possible to provide an object detection apparatus and an object detection method each capable of detecting an object regardless of the distance from a vehicle to the object.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 illustrates vehicle 100 including sensor system 200 according to an embodiment of the present disclosure;

FIG. 2 illustrates a functional configuration example of multiple reflection determiner 21;

FIG. 3 is a flowchart provided for describing operations of sensor system 200;

FIG. 4 is a flowchart provided for describing operations of targeting processing;

FIG. 5 is a flowchart provided for describing processing of multiple reflection determination;

FIG. 6 is a flowchart provided for describing short-distance detection processing;

FIG. 7A illustrates wave reception intensity in a case where no object exists around vehicle 100;

FIG. 7B illustrates the wave reception intensity of a multiple reflected wave reflected by an object that exists at a short distance;

FIG. 7C illustrates the wave reception intensity of a multiple reflected wave reflected by an object that exists at a short distance;

FIG. 8 is a flowchart provided for describing processing of determining whether ranging point 1 is a local maximum point of a wave generated due to reverberation turbulence or a local maximum point of a reflected wave reflected by an object;

FIG. 9 illustrates the wave reception intensity of a multiple reflected wave in a case where an object exists around vehicle 100;

FIG. 10 illustrates wave reception intensity in the case of reverberation turbulence while the wave reception intensity of reverberation decreases from a saturation value to a threshold value for reflected wave detection;

FIG. 11 illustrates wave reception intensity in a case where an object exists in a position farther than a distance corresponding to a reverberation duration time;

FIG. 12A is a flowchart provided for describing operations of sensor system 200 according to other configuration example 1;

FIG. 12B is a flowchart provided for describing operations of sensor system 200 according to other configuration example 1;

FIG. 12C illustrates the wave reception intensity of a reflected wave reflected by each of a plurality of objects;

FIG. 13A is a flowchart provided for describing operations of sensor system 200 according to other configuration example 2;

FIG. 13B is a flowchart provided for describing operations of sensor system 200 according to other configuration example 2;

FIG. 13C is a drawing provided for describing operations of sensor system 200 according to other configuration example 2;

FIG. 14A is a flowchart provided for describing operations of sensor system 200 according to other configuration example 3;

FIG. 14B illustrates the wave reception intensity of a multiple reflected wave before and after the number of pulses is changed; and

FIG. 14C illustrates the wave reception intensity of a multiple reflected wave before and after the number of pulses is changed.

### DETAILED DESCRIPTION

Hereinafter, a suitable embodiment of the present disclosure will be described in detail with reference to the accompanying drawings. Note that, constituent elements having substantially the same functions are denoted by the same reference signs in the present specification and drawings to thus omit repetitive descriptions thereof.

### Embodiment

First, the background leading to the creation of an embodiment according to the present disclosure will be described.

For example, the known art described in PTL 1 discloses the ultrasonic object detection apparatus that utilizes the fact that in a case where an object exists at a short distance, a reflection waveform of the object is added to a reverberation waveform and a reverberation time until the reverberation falls below a detection threshold value is prolonged. When a measured reverberation time is longer than a reference reverberation time in a case where no object exists at a short distance, the ultrasonic object detection apparatus determines that an object exists at a short distance.

Even when the measured reverberation time is not longer than the reference reverberation time, this ultrasonic object detection apparatus compares, in a case where a first reflected wave is detected within a certain time and the wave reception intensity of the first reflected wave is saturated, an addition reverberation time obtained by adding the time, which elapses until the first reflected wave terminates, to the measured reverberation time with the reference reverberation duration time. In a case where the addition reverberation time is prolonged, the ultrasonic object detection apparatus determines that an object exists at a short distance.

In such a known art, it is determined that an object exists at a short distance, in a case where a reverberation duration time or an addition reverberation time obtained by adding the time, which elapses until a reflected wave from the object terminates, to the reverberation time is longer than a reference reverberation time. Accordingly, it may be difficult to detect an object which exists at such a short distance that a reflected wave and reverberation are superposed on each other.

Given the above, it is desirable that an object can be detected regardless of the distance from a vehicle to the object. Hereinafter, an embodiment according to the present disclosure will be described.

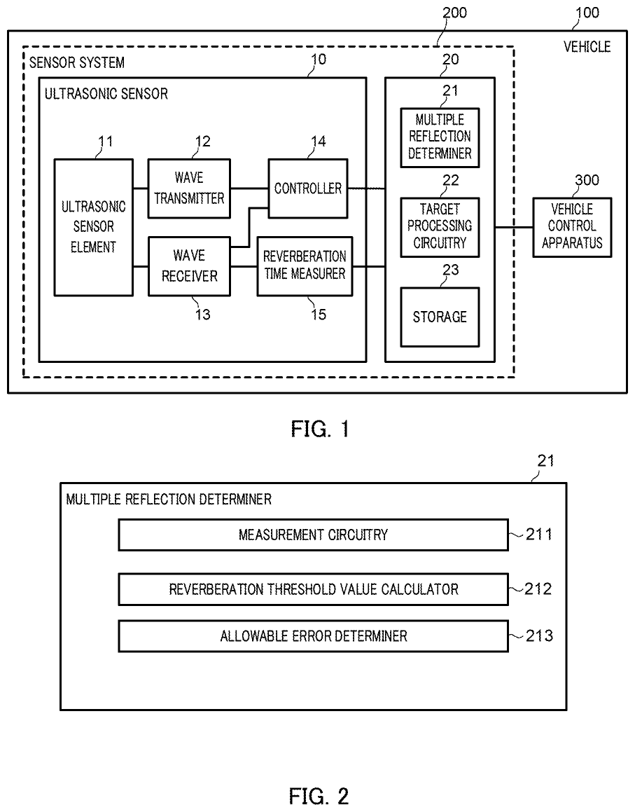

Vehicle 100 in FIG. 1 includes sensor system 200 and vehicle control apparatus 300.

(Sensor System 200)

Sensor system 200 measures the distance from vehicle 100 to an object and transmits information indicating the measured distance to vehicle control apparatus 300. Hereinafter, measurement of the distance from vehicle 100 to an object may be referred to as ranging.

Sensor system 200 includes ultrasonic sensor 10 and object detection apparatus 20.

(Ultrasonic Sensor 10)

Ultrasonic sensor 10 is a sensor for detecting the position of an object that exists around the vehicle and is, for example, sonar.

When ultrasonic sensor 10 oscillates, for example, a pulsed acoustic wave having a constant frequency, the pulsed acoustic wave hits an object or the like around the vehicle and is reflected thereby, and part of the pulsed acoustic wave returns to ultrasonic sensor 10. The shorter the distance from vehicle 100 to the object, the shorter the time from when the pulsed acoustic wave is oscillated by ultrasonic sensor 10 to when part thereof returns to ultrasonic sensor 10.

Utilizing this relationship, sensor system 200 can measure the distance to an object by measuring the reciprocation time from when a pulsed acoustic wave is oscillated to when an echo reflected by an object returns to ultrasonic sensor 10.

Note that, the number of ultrasonic sensors 10 is not limited to one, and sensor system 200 may also be configured to include a plurality of ultrasonic sensors 10. In this case, a plurality of ultrasonic sensors 10 is connected to object detection apparatus 20.

Ultrasonic sensor 10 includes ultrasonic sensor element 11, wave transmitter 12, wave receiver 13, controller 14, and reverberation time measurer 15.

(Ultrasonic Sensor Element 11) Ultrasonic sensor element 11 is an element that transmits and receives ultrasound.

Hereinafter, ultrasound transmission by ultrasonic sensor element 11 may be referred to as wave transmission and ultrasound reception by ultrasonic sensor element 11 may be referred to as wave reception.

(Wave Transmitter 12)

Wave transmitter 12 generates, based on a signal transmitted by controller 14, an analog signal subjected to AM modulation at a predetermined frequency, amplifies the analog signal, and transmits the analog signal to ultrasonic sensor element 11. Wave transmitter 12 transmits such an analog signal to ultrasonic sensor element 11 periodically. Thus, ultrasonic sensor element 11 transmits ultrasound periodically.

(Wave Receiver 13)

Wave receiver 13 receives a signal generated by vibration of ultrasonic sensor element 11 that has received ultrasound. Wave receiver 13 then subjects this signal to AM demodulation at a predetermined frequency, and further generates a digital signal obtained by A/D converting an envelope waveform obtained by envelope detection. Wave receiver 13 transmits the generated digital signal to each of controller 14 and reverberation time measurer 15.

(Controller 14)

Controller 14 outputs a signal for indicating wave transmitter 12 to generate an analog signal. Further, in a case where controller 14 receives a digital signal transmitted from wave receiver 13, controller 14 determines, based on the digital signal transmitted from wave receiver 13 and a threshold value for reflected wave detection which is used to detect the reception intensity of a reflected wave (wave reception intensity), whether the intensity of a signal detected by ultrasonic sensor element 11 exceeds the threshold value for reflected wave detection.

In a case where the intensity of a signal detected by ultrasonic sensor element 11 exceeds the threshold value for reflected wave detection, controller 14 transmits reflected wave information on the reflected wave to object detection apparatus 20.

The reflected wave information includes, for example, a local maximum point intensity of a reflected wave which exceeds the threshold value for reflected wave detection, and a local maximum point measurement time. The local maximum point measurement time is a time from when ultrasonic sensor 10 transmits ultrasound to when the intensity at a local maximum point thereof is measured.

(Reverberation Time Measurer 15)

In a case where reverberation time measurer 15 receives a digital signal transmitted from wave receiver 13, reverberation time measurer 15 measures, based on the digital signal transmitted from wave receiver 13 and a threshold value for reverberation measurement which is used to measure a reverberation duration time, a reverberation duration time, and transmits information indicating the measured reverberation duration time to object detection apparatus 20.

The threshold value for reverberation measurement is preconfigured to reverberation time measurer 15. The reverberation duration time is a time from when ultrasound is transmitted to when the intensity of a signal detected by ultrasonic sensor element 11 falls below the threshold value for reverberation measurement by a predetermined amount.

(Object Detection Apparatus 20)

Object detection apparatus 20 is an electronic control unit including a central processing unit (CPU), a random access memory (RAM), a read only memory (ROM), and the like.

Object detection apparatus 20 includes multiple reflection determiner 21, target processing circuitry 22, and storage 23.

(Multiple Reflection Determiner 21)

In a case where two or more reflected waves are detected with respect to one wave transmission based on the reflected wave information transmitted from ultrasonic sensor 10, multiple reflection determiner 21 excludes a reflected wave(s) due to multiple reflection from the two or more reflected waves, and selects only reflected wave information on a reflected wave received in the shortest time from the time of the wave transmission. Note that, this reflected wave also includes a reflected wave hidden in reverberation. Multiple reflection determiner 21 transmits the selected reflected wave information to target processing circuitry 22.

The multiple reflected wave is an acoustic wave in which ultrasound transmitted from ultrasonic sensor 10 is reflected a plurality of times between ultrasonic sensor 10 and an object.

(Target Processing Circuitry 22)

Target processing circuitry 22 calculates the distance from vehicle 100 to an object based on the reflected wave information transmitted from multiple reflection determiner 21. Further, target processing circuitry 22 extracts, based on the reflected wave information, the wave reception intensity at a ranging point indicating the position of the detected object.

(Storage 23)

Storage 23 stores a program for realizing various functions of object detection apparatus 20, or the like.

(Vehicle Control Apparatus 300)

Vehicle control apparatus 300 is an electronic control unit that performs various control processing related to driving assistance in vehicle 100, and is an electronic control unit (ECU), or the like.

Next, the functional configuration of multiple reflection determiner 21 will be described with reference to FIG. 2.

(Multiple Reflection Determiner 21)

Multiple reflection determiner 21 includes measurement circuitry 211, reverberation threshold value calculator 212, and allowable error determiner 213.

(Measurement Circuitry 211)

Measurement circuitry 211 measures a local maximum point of a first reflected wave of an acoustic wave emitted from ultrasonic sensor 10 provided in vehicle 100 and a local maximum point of a second reflected wave consecutively after the first reflected wave.

For example, measurement circuitry 211 gives, based on local maximum point intensities of reflected waves included in the reflected wave information transmitted from controller 14, numbers such as “1” and “2” in order closer to the time of the wave transmission to the respective local maximum points of a plurality of reflected waves included in a multiple reflected wave. The numbers are given for distinguishing between ranging points each of which indicates the position of a detected object.

Measurement circuitry 211 transmits, to target processing circuitry 22, information on reflected waves to which positioning points are given.

(First Determination Processing of Target Processing Circuitry 22)

Target processing circuitry 22 determines whether the position of a first local maximum point is closer than a distance twice a reverberation distance corresponding to a reverberation duration time of ultrasonic sensor 10.

Note that, the above distance may be, for example, a distance within a predetermined error range of the distance twice the reverberation distance. In this case, the predetermined error range may be, for example, 10% to 20% before and after the distance twice the reverberation distance.

The first local maximum point indicates, for example, the position of a local maximum point (ranging point 1) of a reflected wave, to which the aforementioned number “1” is given.

(Reason for Performing First Determination Processing)

In a case where an object is located farther than a distance twice a reverberation distance, a reflected wave and reverberation are not superposed on each other. For this reason, determining whether the position of ranging point 1 is closer than a distance twice a reverberation distance makes it possible to distinguish whether a reflected wave is a reflected wave reflected by an object which exists at such a short distance that part of a multiple reflected wave and reverberation are superposed on each other, or a reflected wave reflected by an object that exists in the position of ranging point 1.

(Second Determination Processing of Target Processing Circuitry 22)

In a case where the position of the first local maximum point (ranging point 1) is closer than the distance twice the reverberation distance corresponding to the reverberation duration time of ultrasonic sensor 10, target processing circuitry 22 determines whether the position of the first local maximum point (ranging point 1) is farther than the reverberation distance corresponding to the reverberation duration time.

Note that, the reverberation distance corresponding to the reverberation duration time may be, for example, a distance within a predetermined error range of the reverberation distance.

In this case, the predetermined error range may be, for example, 10% to 20% before and after the predetermined error range of the reverberation distance.

(Reason for Performing Second Determination Processing)

In a case where an object is located closer than the reverberation distance, a local maximum point of a reflected wave due to reverberation turbulence or the like may be detected, but a local maximum point of a reflected wave reflected by the object is not detected. For this reason, determining whether the position of ranging point 1 is farther than the reverberation distance corresponding to the reverberation duration time makes it possible to distinguish whether a reflected wave is a wave due to reverberation disturbance or the like or a reflected wave reflected by the object.

(Third Determination Processing of Target Processing Circuitry 22)

In a case where the position of the first local maximum point (ranging point 1) is farther than the reverberation distance corresponding to the reverberation duration time, target processing circuitry 22 may determine whether the position of a second local maximum point is at a distance 3/2 times a distance from ultrasonic sensor 10 to the position of the first local maximum point (ranging point 1).

Note that, the distance 3/2 times the distance from ultrasonic sensor 10 to the position of the first local maximum point may be a distance within a predetermined error range of the distance 3/2 times the distance from ultrasonic sensor 10 to the position of the first local maximum point.

In this case, the predetermined error range may be, for example, 10 to 20% before and after the distance 3/2 times the distance from ultrasonic sensor 10 to the position of the first local maximum point.

The second local maximum point indicates, for example, the position of a local maximum point (ranging point 2) of a reflected wave, to which the number “2” is given.

(Ranging by Target Processing Circuitry 22)

In a case where the position of the second local maximum point (ranging point 2) is at the distance 3/2 times the distance from ultrasonic sensor 10 to the position of the first local maximum point (ranging point 1), target processing circuitry 22 may perform ranging of an object by assuming that the object exists at a distance ½ times the distance from ultrasonic sensor 10 to the first local maximum point.

Note that, the distance ½ times the distance from ultrasonic sensor 10 to the first local maximum point may be a distance within a predetermined error range of the distance ½ times the distance from ultrasonic sensor 10 to the first local maximum point.

In this case, the predetermined error range may be, for example, 10 to 20% before and after the distance ½ times the distance from ultrasonic sensor 10 to the position of the first local maximum point.

In a case where ranging point 2 does not exist in a position corresponding to the distance 3/2 times the distance from ultrasonic sensor 10 to the position of the first local maximum point, target processing circuitry 22 performs ranging by assuming that an object exists in the position of ranging point 1.

(Reverberation Threshold Value Calculator 212)

Reverberation threshold value calculator 212 calculates a reverberation time threshold value represented by predetermined function f (reverberation duration time) each time an acoustic wave is emitted from ultrasonic sensor 10. The reverberation time threshold value is a time threshold value that defines a time during which a saturation state of reverberation continues, and is configured to, for example, a time from when the wave reception intensity of reverberation is in the saturation state to when the wave reception intensity slightly decreases.

Reverberation threshold value calculator 212 preferably changes the length of the calculated reverberation time threshold value based on at least one parameter of the reverberation duration time and/or the number of pulses of the acoustic wave.

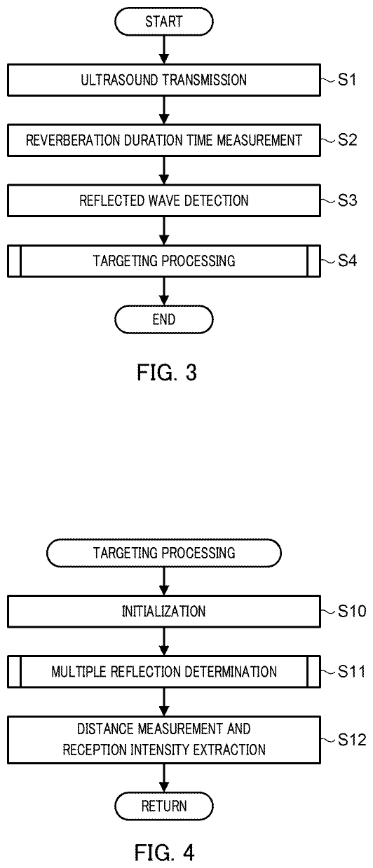

Next, the outline of operations of sensor system 200 will be described with reference to FIGS. 3 and 4.

When ultrasound is transmitted from ultrasonic sensor 10 in step S1 illustrated in FIG. 3, reverberation time measurer 15 measures a reverberation duration time in step S2 and controller 14 detects a reflected wave in step S3.

Next, in step S4, object detection apparatus 20 executes targeting processing based on the local maximum point intensity and local maximum point measurement time of the reflected wave that are included in reflected wave information transmitted from controller 14.

Next, the targeting processing will be described with reference to FIG. 4. In step S10, object detection apparatus 20 initializes target information of the reflected wave.

The target information of the reflected wave includes the distance from ultrasonic sensor 10 to an object and a local maximum point intensity of the reflected wave, which exceeds a threshold value for reflected wave detection.

The distance from ultrasonic sensor 10 to the object is calculated by, for example, multiplying the time from the time when ultrasonic sensor 10 starts wave transmission to the time when the local maximum point of the reflected wave, of which the intensity exceeds the threshold value for reflected wave detection, is measured, by a speed ½ times the speed of sound.

Next, in step S11, object detection apparatus 20 executes multiple reflection determination. In the multiple reflection determination, determination related to a reflected wave from an object, which exists at such a short distance that part of a multiple reflected wave and reverberation are superposed on each other, is executed. Then, reflected wave information on the reflected wave from the object determined in the multiple reflection determination is transmitted to target processing circuitry 22.

Next, in step S12, target processing circuitry 22 calculates the distance from vehicle 100 to the object based on the reflected wave information and extracts the reception intensity of the reflected wave at a ranging point.

Note that, a series of processing illustrated in FIGS. 3 and 4 is performed periodically at a constant period.

Note that, in a case where a plurality of ultrasonic sensors 10 is used for sensor system 200, the series of processing illustrated in FIGS. 3 and 4 is periodically executed at a constant period, consecutively in the order of, for example, a first ultrasonic sensor, a second ultrasonic sensor, and a third ultrasonic sensor.

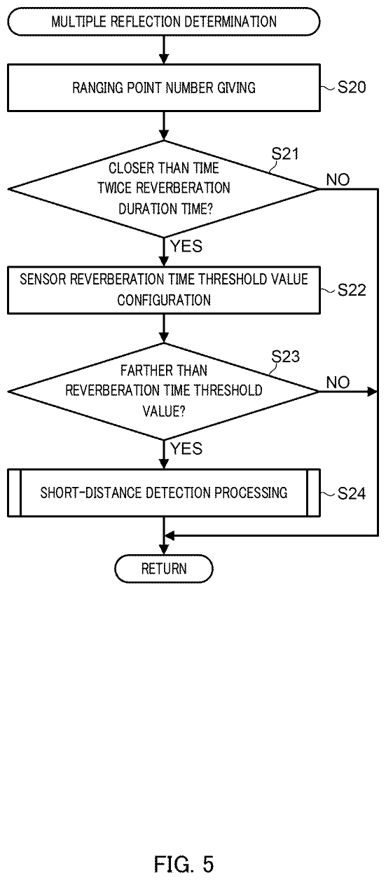

Next, processing of the multiple reflection determination will be described with reference to FIG. 5.

In step S20, multiple reflection determiner 21 gives, based on local maximum point intensities of reflected waves included in the reflected wave information transmitted from controller 14, the numbers of ranging points to the respective local maximum points of a plurality of reflected waves.

In step S21, multiple reflection determiner 21 determines whether the position of ranging point 1 is closer than a distance corresponding to a time twice the reverberation duration time.

In a case where the position of ranging point 1 is closer than the distance corresponding to the time twice the reverberation duration time (step S21, YES), the processing in step S22 is executed.

In a case where the position of ranging point 1 is farther than the distance corresponding to the time twice the reverberation duration time (step S21, NO), the processing of the multiple reflection determination ends.

In step S22, a reverberation time threshold value is configured by reverberation threshold value calculator 212.

Next, in step S23, target processing circuitry 22 determines, based on the reverberation time threshold value configured by reverberation threshold value calculator 212, whether the position of ranging point 1 is farther than a position corresponding to the reverberation time threshold value.

In a case where the position of ranging point 1 is farther than the position corresponding to the reverberation time threshold value (step 23, YES), target processing circuitry 22 executes short-distance detection processing in step S24.

In a case where the position of ranging point 1 is closer than the distance corresponding to the reverberation time threshold value (step S23, NO), the processing of the multiple reflection determination ends.

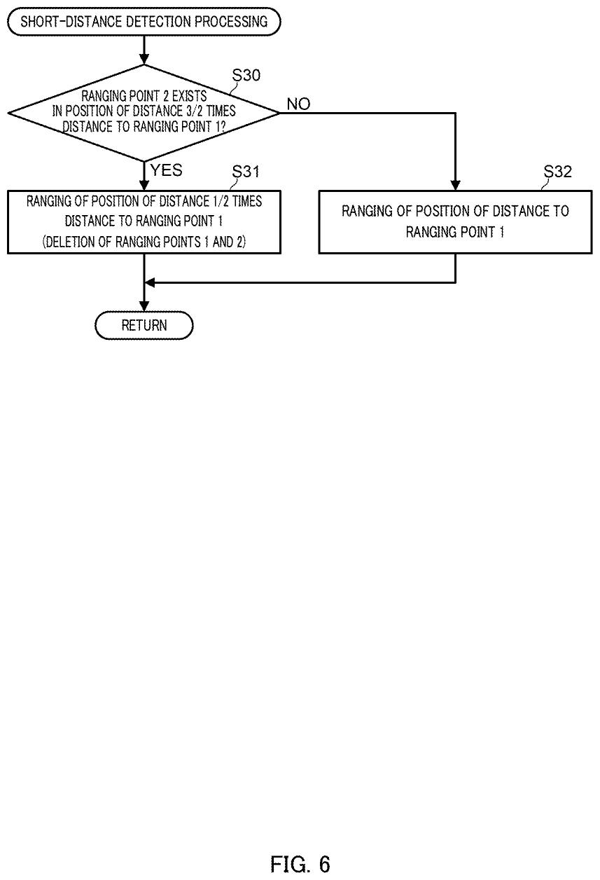

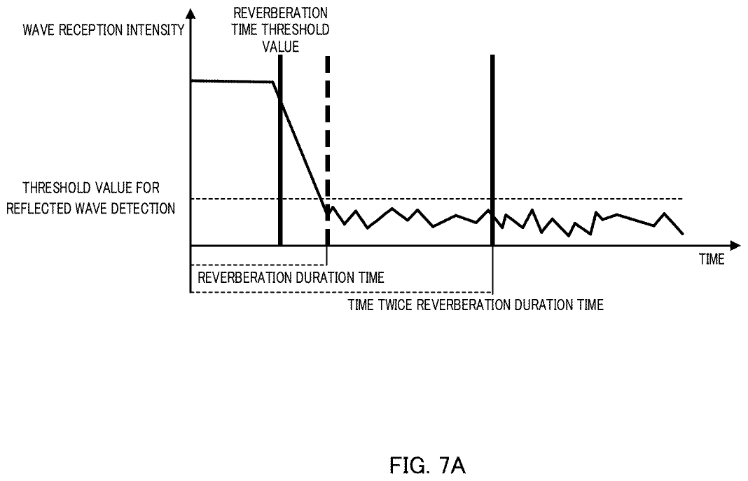

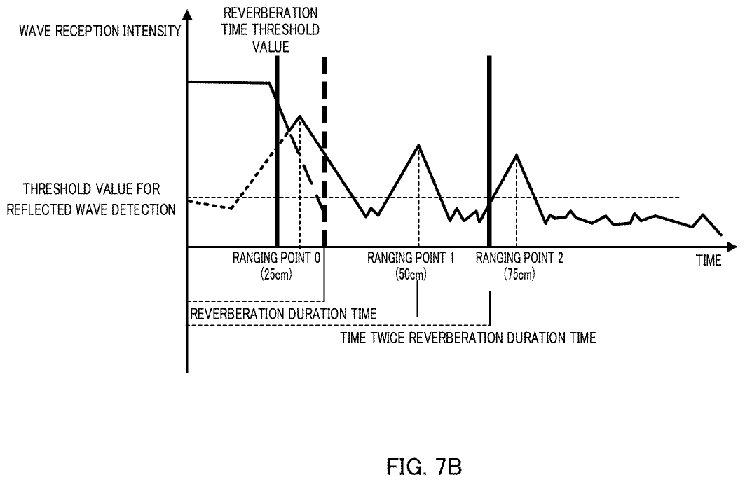

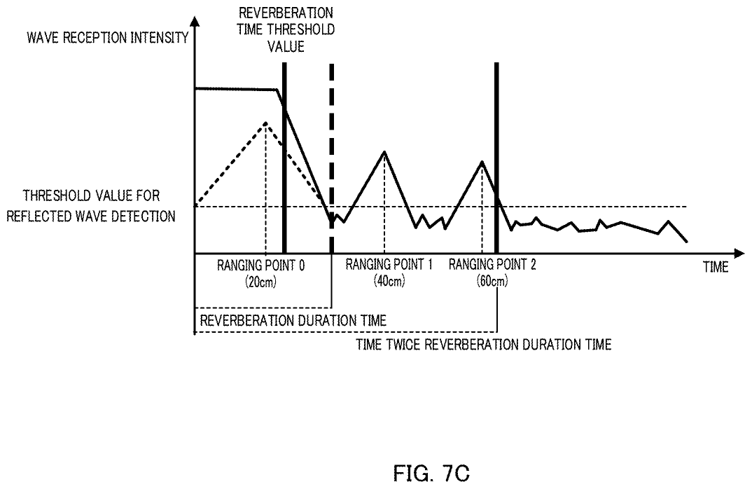

Next, the short-distance detection processing will be described with reference to FIGS. 6, 7A, 7B, and 7C.

In FIG. 7A, the vertical axis represents wave reception intensity and the horizontal axis represents time. In a case where no object exists around vehicle 100, the wave reception intensity of reverberation is saturated for a certain time, then begins to decrease, and decreases to a value below the threshold value for reflected wave detection as illustrated in FIG. 7A.

In step S30 in FIG. 6, target processing circuitry 22 determines whether ranging point 2 exists in a position corresponding to a distance 3/2 times a distance from ultrasonic sensor 10 to ranging point 1.

In each of FIGS. 7B and 7C, the vertical axis represents wave reception intensity and the horizontal axis represents time. In a case where an object exists around vehicle 100, wave reception intensities exceeding the threshold value for reflected wave detection are measured as illustrated in FIGS. 7B and 7C.

In FIG. 7B, the wave reception intensity at the local maximum point at ranging point indicates a value higher than the wave reception intensity of reverberation, which slightly decreases from the saturation state. In FIG. 7C, the wave reception intensity at the local maximum point at ranging point 0 indicates a value lower than the wave reception intensity of reverberation in the saturation state.

As illustrated in FIG. 7B, the distance from ultrasonic sensor 10 to ranging point 0 is, for example, 25 cm. The distance from ultrasonic sensor 10 to ranging point 1 is 50 cm. The position of ranging point 1 is a position corresponding to a distance twice the distance from ultrasonic sensor 10 to ranging point 0.

The distance from ultrasonic sensor 10 to ranging point 2 is 75 cm. The position of ranging point 2 is a position corresponding to a distance 3/2 times the distance from ultrasonic sensor 10 to ranging point 1.

For this reason, in a case where ranging point 2 exists in the position corresponding to the distance 3/2 times the distance from ultrasonic sensor 10 to ranging point 1 (step S30, YES), target processing circuitry 22 performs, in step S31, ranging by assuming that an object exists in the position (ranging point 0) corresponding to the distance ½ times the distance from ultrasonic sensor 10 to ranging point 1.

FIG. 7C illustrates the wave reception intensity of a reflected wave reflected by an object which exists at such a short distance that part of a multiple reflected wave and reverberation are superposed on each other. The vertical axis represents wave reception intensity and the horizontal axis represents time.

As illustrated in FIG. 7C, in a case where part of a multiple reflected wave and reverberation are superposed on each other, the distance from ultrasonic sensor 10 to ranging point 0, which is the position of a local maximum point of a reflected wave, where the reflected wave and the reverberation are superposed on each other, is, for example, 20 cm.

The distance from ultrasonic sensor 10 to ranging point 1, which is the position of a local maximum point of a reflected wave to be measured after the reflected wave, where the reflected wave and the reverberation are superposed on each other, is 40 cm. The position of ranging point 1 is a position corresponding to a distance twice the distance from ultrasonic sensor 10 to ranging point 0.

The distance from ultrasonic sensor 10 to ranging point 2, which is the position of a local maximum point of a reflected wave to be measured thereafter, is 60 cm. The position of ranging point 2 is a position corresponding to a distance 3/2 times the distance from ultrasonic sensor 10 to ranging point 1.

For this reason, in a case where ranging point 2 exists in the position corresponding to the distance 3/2 times the distance from ultrasonic sensor 10 to ranging point 1 (step S30, YES), target processing circuitry 22 performs, in step S31, ranging by assuming that an object exists in the position (ranging point 0) corresponding to the distance ½ times the distance from ultrasonic sensor 10 to ranging point 1.

In this case, target processing circuitry 22 determines that each of ranging points 1 and 2 is not a ranging point in a position in which an object exists, but is a ranging point due to multiple reflection, and deletes data on these ranging points.

Step S30 will be described again. In a case where ranging point 2 does not exist in the position corresponding to the distance 3/2 times the distance from ultrasonic sensor 10 to ranging point 1 (step S30, NO), target processing circuitry 22 performs, in step S32, ranging by assuming that an object exists in the position of ranging point 1.

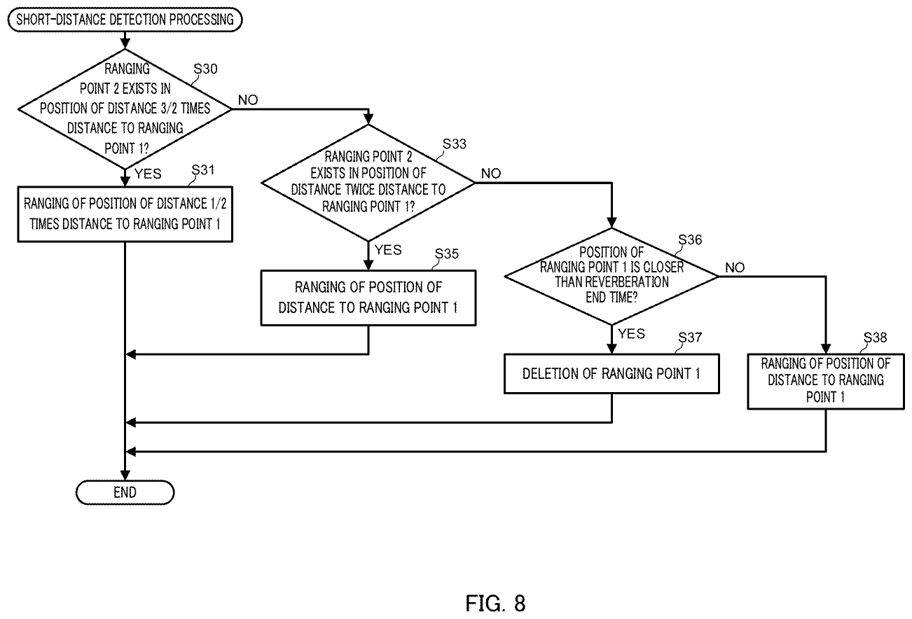

Next, processing of determining whether ranging point 1 is a local maximum point of a wave generated due to reverberation turbulence or a local maximum point of a reflected wave reflected by an object will be described with reference to FIGS. 8, 9, 10, and 11.

In a case where ranging point 2 does not exist in the position corresponding to the distance 3/2 times the distance from ultrasonic sensor 10 to ranging point 1 in step S30 in FIG. 8 (step S30, NO), the processing in step S33 is executed.

In step S33, target processing circuitry 22 determines whether ranging point 2 exists in a position corresponding to a distance twice the distance from ultrasonic sensor 10 to ranging point 1.

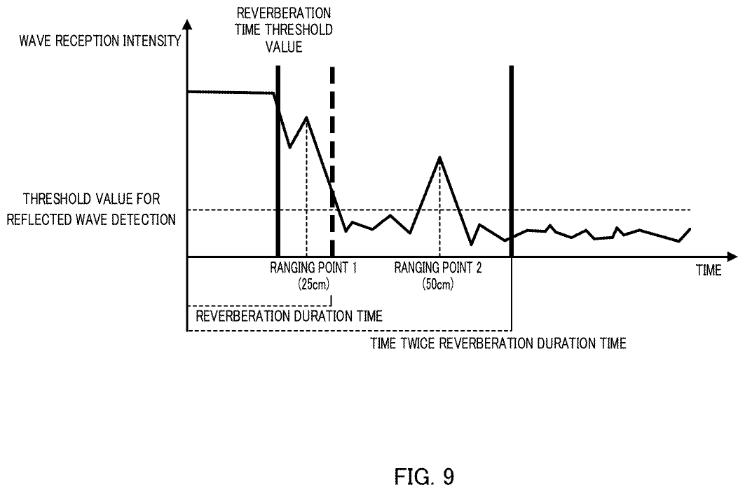

In FIG. 9, the vertical axis represents wave reception intensity and the horizontal axis represents time.

As illustrated in FIG. 9, in a case where an object exists in a position closer than the distance corresponding to the time twice the reverberation duration time, ranging point 2 exists in the position (50 cm) corresponding to the distance twice the position (25 cm) of ranging point 1.

Accordingly, in a case where ranging point 2 exists in the position corresponding to the distance twice the distance from ultrasonic sensor 10 to ranging point 1 (step S33, YES), target processing circuitry 22 performs, in step S35, ranging by assuming that an object exists in the position of ranging point 1.

In this case, target processing circuitry 22 determines that ranging point 2 is a ranging point due to multiple reflection and deletes data on ranging point 2.

Step S33 will be described again. In a case where ranging point 2 does not exist in the position corresponding to the distance twice the distance from ultrasonic sensor 10 to ranging point 1 (step S33, NO), target processing circuitry 22 determines in step S36 whether the position of ranging point 1 is closer than a distance corresponding to a reverberation end time.

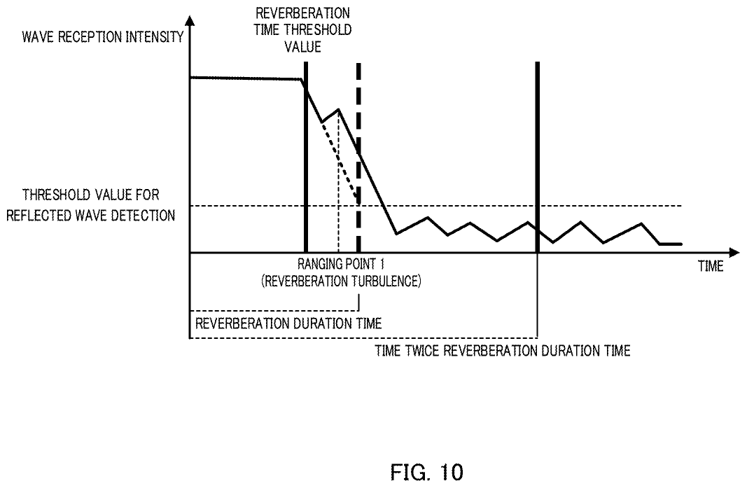

In FIG. 10, the vertical axis represents wave reception intensity and the horizontal axis represents time.

The wave reception intensity in a case where reverberation is not disturbed decreases from the saturation value to the threshold value for reflected wave detection at a constant rate of change.

In a case where reverberation is disturbed, however, the wave reception intensity decreases once, then slightly increases, and decreases again as illustrated in FIG. 10.

For this reason, since the wave reception intensity becomes maximum in a position in which reverberation turbulence occurs, the position may be detected as a ranging point.

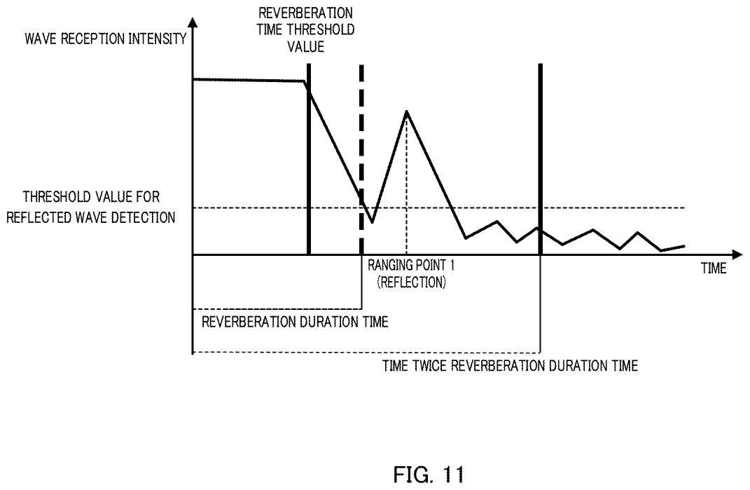

In FIG. 11, the vertical axis represents wave reception intensity and the horizontal axis represents time.

In a case where ranging point 2 does not exist in the position corresponding to the distance 3/2 times the distance from ultrasonic sensor 10 to ranging point 1 in step S30 described above, no multiple reflected wave has occurred.

In a case where no multiple reflected wave has occurred as described above, ranging point 1 whose position is farther than the distance corresponding to the reverberation duration time can be regarded not as a ranging point due to reverberation turbulence, but as a ranging point due to a reflected wave as illustrated in FIG. 11.

Accordingly, in a case where the position of ranging point 1 is closer than the distance corresponding to the reverberation end time in step S36 (step S36, YES), target processing circuitry 22 determines that ranging point 1 is caused by reverberation turbulence as illustrated in FIG. 10.

In this case, target processing circuitry 22 does not perform, in step S37, ranging by deleting data on ranging point 1 as no object exists in the position of the distance to ranging point 1.

In a case where the position of ranging point 1 is farther than the distance corresponding to the reverberation end time (step S36, NO), on the other hand, target processing circuitry 22 determines that an object exists at ranging point 1 as illustrated in FIG. 11, and performs ranging in step 38.

(Determination by Allowable Error Determiner 213)

Note that, each of ranging points 1 and 2 has a slight error, and thus, the distance 3/2 times the distance from ultrasonic sensor 10 to ranging point 1 or the distance twice the distance from ultrasonic sensor 10 to ranging point 1 may not coincide with the distance from ultrasonic sensor 10 to ranging point 2.

Even in this case, certain errors are allowed for ranging points 1 and 2. Accordingly, when the determinations in steps S30 and S33 are performed, allowable error determiner 213 may be configured to determine whether the respective positional relationships of ranging points 1 and 2 are valid.

For example, in a case where acceptable error determiner 213 determines the positional relationships of ranging points 1 and 2 in steps S30 and S33, acceptable error determiner 213 regards the determination as valid when each positional relationship of ranging points 1 and 2 is within an allowable error range with respect to each target position, and regards the determination as invalid when each positional relationship thereof is outside the allowable error range with respect to each target position.

Note that, it is assumed that information on the allowable error ranges is configured to allowable error determiner 213.

### Other Configuration Example 1 of Sensor System 200

Multiple reflection may occur for one object and for a plurality of objects. For this reason, sensor system 200 may also be configured to compare the wave reception intensity at ranging point 1 with the wave reception intensity at ranging point 2 to determine whether ranging points 1 and 2 correspond to local maximum points of a multiple reflected wave due to one object which exists at such a short distance that part of a multiple reflected wave and reverberation are superposed on each other, or correspond to local maximum points of a plurality of reflected waves due to objects which exist at ranging points 1 and 2, respectively.

In this case, when the reflected waves are caused by multiple reflection due to one object which exists at such a short distance that part of a multiple reflected wave and reverberation are superposed on each other, sensor system 200 utilizes that the wave reception intensity at ranging point 1 is greater than the wave reception intensity at ranging point 2.

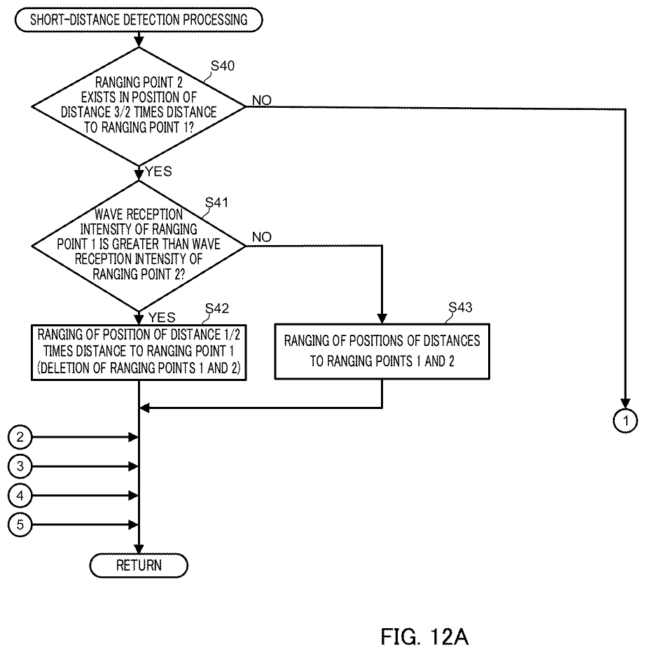

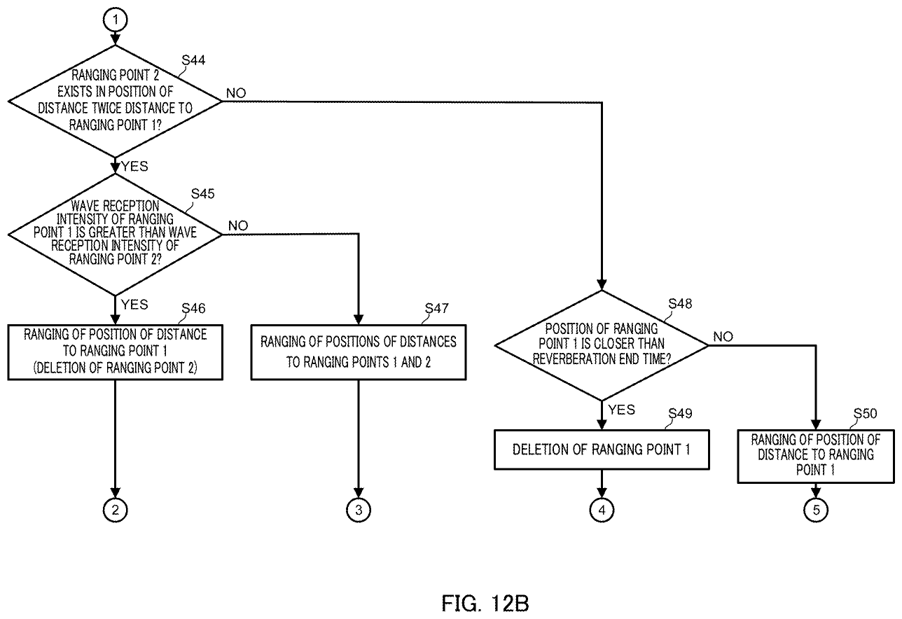

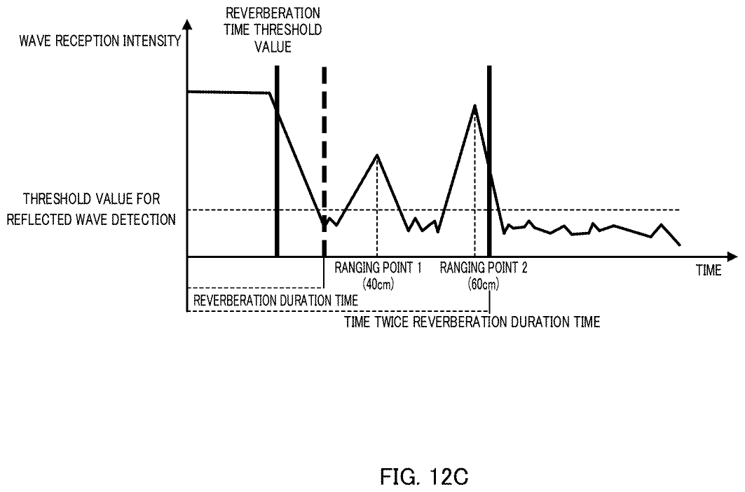

Operations of sensor system 200 according to other configuration example 1 will be described with reference to FIGS. 12A, 12B, and 12C.

In step S40 illustrated in FIG. 12A, target processing circuitry 22 determines whether ranging point 2 exists in the position corresponding to the distance 3/2 times the distance from ultrasonic sensor 10 to ranging point 1.

In a case where ranging point 2 exists in the position corresponding to the distance 3/2 times the distance from ultrasonic sensor 10 to ranging point 1 (step S40, YES), target processing circuitry 22 determines in step S41 whether the wave reception intensity at ranging point 1 is greater than the wave reception intensity at ranging point 2.

In a case where the wave reception intensity at ranging point 1 is greater than the wave reception intensity at ranging point 2 (step S41, YES), target processing circuitry 22 determines in step S42 that an object exists in the position (ranging point 0) corresponding to the distance ½ times the distance from ultrasonic sensor 10 to ranging point 1, and performs ranging by assuming that ranging points 1 and 2 involve multiple reflection due to the object.

Step S41 will be described again. In a case where the wave reception intensity at ranging point 1 is less than the wave reception intensity at ranging point 2 (step S41, NO), target processing circuitry 22 performs, in step S43, ranging by assuming that the reflected waves are reflected waves due to two objects that exist in the respective positions of ranging points 1 and 2 as illustrated in FIG. 12C.

In FIG. 12C, the vertical axis represents wave reception intensity and the horizontal axis represents time.

For example, in a case where a curb and a wall exist around vehicle 100, the wave reception intensity of ultrasound reflected by the curb that exists at ranging point 1 may be less than the wave reception intensity of ultrasound reflected by the wall that exists at ranging point 2 as illustrated in FIG. 12C.

Step S40 will be described again. In a case where ranging point 2 does not exist in the position corresponding to the distance 3/2 times the distance from ultrasonic sensor 10 to ranging point 1 (step S40, NO), the processing in step S44 and thereafter illustrated in 12B is executed.

In step S44 illustrated in FIG. 12B, target processing circuitry 22 determines whether ranging point 2 exists in the position corresponding to the distance twice the distance from ultrasonic sensor 10 to ranging point 1.

In a case where ranging point 2 exists in the position corresponding to the distance twice the distance from ultrasonic sensor 10 to ranging point 1 (step S44, YES), target processing circuitry 22 determines in step S45 whether the wave reception intensity at ranging point 1 is greater than the wave reception intensity at ranging point 2.

In a case where the wave reception intensity at ranging point 1 is greater than the wave reception intensity at ranging point 2 (step S45, YES), target processing circuitry 22 performs, in step S46, ranging by assuming that an object exists in the position of ranging point 1.

Step S45 will be described again. In a case where the wave reception intensity at ranging point 1 is less than the wave reception intensity at ranging point 2 (step S45, NO), target processing circuitry 22 performs, in step S47, ranging by assuming that the reflected waves are reflected waves due to two objects that exist in the respective positions of ranging points 1 and 2.

Step S44 will be described again. In a case where ranging point 2 does not exist in the position corresponding to the distance twice the distance from ultrasonic sensor 10 to ranging point 1 (step S44, NO), target processing circuitry 22 determines in step S48 whether the position of ranging point 1 is closer than the distance corresponding to the time twice the reverberation duration time.

In a case where the position of ranging point 1 is closer than the distance corresponding to the time twice the reverberation duration time (step S48, YES), target processing circuitry 22 does not perform, in step S49, ranging by deleting data on ranging point 1 as no object exists in the position of the distance to ranging point 1.

Step S48 will be described again. In a case where the position of ranging point 1 is farther than the distance corresponding to the time twice the reverberation duration time (step S48, NO), target processing circuitry 22 performs, in step S50, ranging by assuming that an object exists in the position of ranging point 1.

### Other Configuration Example 2 of Sensor System 200

Sensor system 200 may also be configured to perform a plurality of times of wave transmission to thereby decide the position of an object which exists at such a short distance that part of a multiple reflected wave and reverberation are superposed on each other.

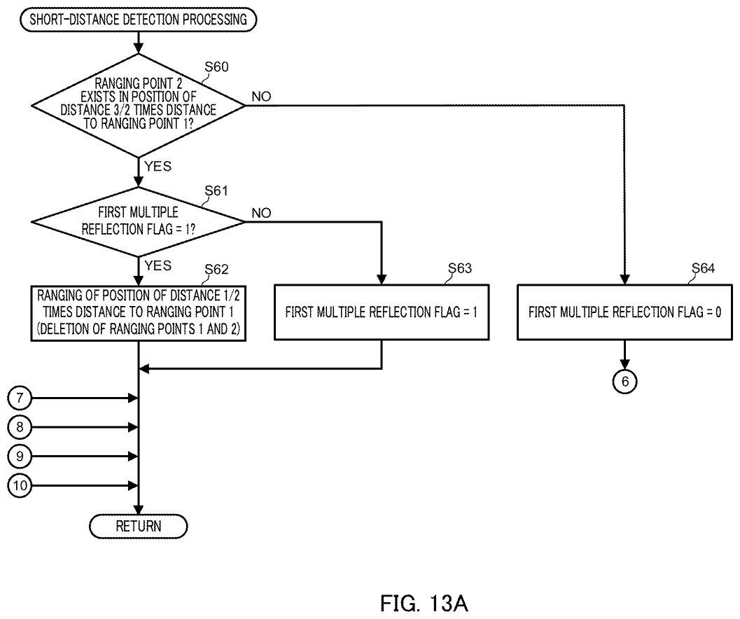

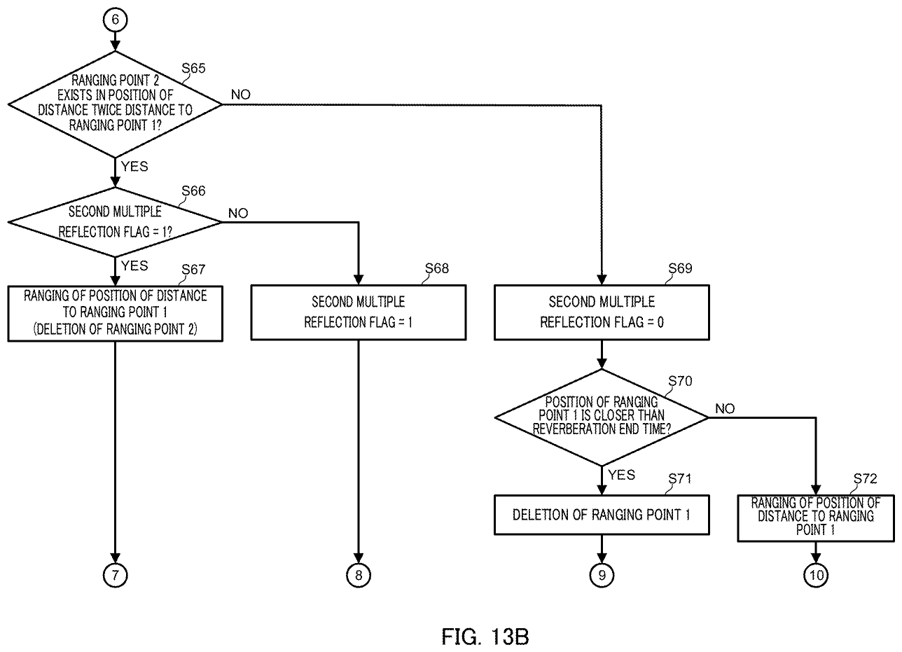

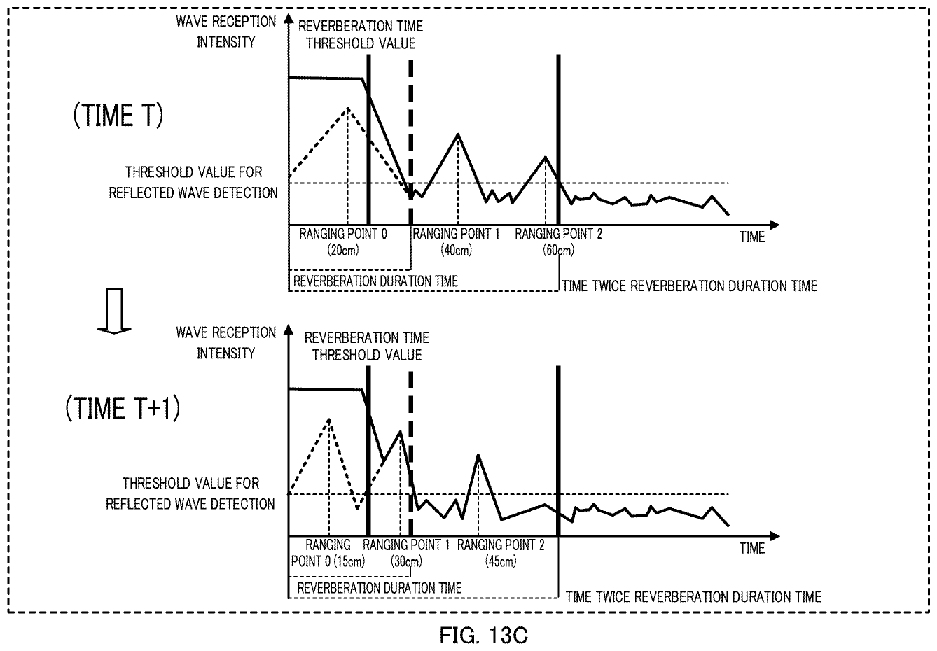

Operations of sensor system 200 according to other configuration example 2 will be described with reference to FIGS. 13A, 13B, and 13C.

In a series of processing illustrated in FIGS. 13A and 13B, a first multiple reflection flag represents a flag for identifying whether ranging point 2 exists in the position corresponding to the distance 3/2 times the distance to ranging point 1, and a second multiple reflection flag represents a flag for identifying whether ranging point 2 exists in the position corresponding to the distance twice the distance to ranging point 1.

The first multiple reflection flag is configured to be 1 in a case where ranging point 2 exists in the position corresponding to the distance 3/2 times the distance to ranging point 1.

The second multiple reflection flag is configured to be 1 in a case where ranging point 2 exists in the position corresponding to the distance twice the distance to ranging point 1.

The series of processing illustrated in FIGS. 13A and 13B starts, for example, in a state in which both the first and second multiple reflection flags are zero.

In FIG. 13C, the vertical axis represents wave reception intensity and the horizontal axis represents time.

FIG. 13C illustrates each ranging point in a case where a first ultrasound transmission is performed at time T, and each ranging point in a case where a second ultrasound transmission is performed at time T+1 after a certain time has elapsed from time T.

In step S60 illustrated in FIG. 13A, target processing circuitry 22 determines whether ranging point 2 exists in the position corresponding to the distance 3/2 times the distance from ultrasonic sensor 10 to ranging point 1.

In a case where ranging point 2 does not exist in the position corresponding to the distance 3/2 times the distance from ultrasonic sensor 10 to ranging point 1 (step 60, NO), target processing circuitry 22 configures the first multiple reflection flag to be 0 in step S64.

Note that, in a case where the first multiple reflection flag is 0 at the time of the determination in step S60, the first multiple reflection flag is maintained to be 0 in step S64, whereas in a case where the first multiple reflection flag is 1 at the time of the determination in step S60, the first multiple reflection flag is changed to 0 in step S64.

Next, in step S65 illustrated in FIG. 13B, target processing circuitry 22 determines whether ranging point 2 exists in the position corresponding to the distance twice the distance from ultrasonic sensor 10 to ranging point 1.

In a case where ranging point 2 exists in the position corresponding to the distance twice the distance from ultrasonic sensor 10 to ranging point 1 (step 65, YES), target processing circuitry 22 determines in step S66 whether the second multiple reflection flag is 1. Note that, target processing circuitry 22 may determine based on the second multiple reflection flag whether ranging point 2 has existed in the position corresponding to the distance twice the distance to ranging point 1 in the first ultrasound transmission.

In a case where the second multiple reflection flag is 1 (step 66, YES), ranging point 2 has existed in the position corresponding to the distance twice the distance to ranging point 1 in the first ultrasound transmission, and thus, target processing circuitry 22 performs, in step S67, ranging by assuming that an object exists in the position of ranging point 1.

In a case where the second multiple reflection flag is 0 (step 66, NO), ranging point 2 has not existed in the position corresponding to the distance twice the distance to ranging point 1 in the first ultrasound transmission, and thus, in step S68, target processing circuitry 22 only configures the second multiple reflection flag to be 1 and does not perform ranging.

Step S65 will be described again. In a case where ranging point 2 does not exist in the position corresponding to the distance twice the distance from ultrasonic sensor 10 to ranging point 1 (step 65, NO), target processing circuitry 22 configures the second multiple reflection flag to be 0 in step S69.

Thus, a short-distance object that is difficult to detect by the first wave transmission can be detected by the second and subsequent wave transmissions.

Next, in step S70, target processing circuitry 22 determines whether the position of ranging point 1 is closer than the distance corresponding to the time twice the reverberation duration time.

In a case where the position of ranging point 1 is closer than the distance corresponding to the time twice the reverberation duration time (step 70, YES), target processing circuitry 22 does not perform, in step S71, ranging by deleting data on ranging point 1 as no object exists in the position of the distance to ranging point 1.

In a case where the position of ranging point 1 is farther than the distance corresponding to the time twice the reverberation duration time (step 70, NO), target processing circuitry 22 performs, in step S72, ranging by assuming that an object exists in the position of ranging point 1.

Step S60 will be described again. In a case where ranging point 2 exists in the position corresponding to the distance 3/2 times the distance from ultrasonic sensor 10 to ranging point 1 (step 60, YES), target processing circuitry 22 determines in step S61 whether the first multiple reflection flag is 1.

In step S61, it is determined based on the first multiple reflection flag whether ranging point 2 has existed in the position corresponding to the distance 3/2 times the distance to ranging point 1 in the first ultrasound transmission.

For example, in a case where the first ultrasound transmission is performed at time T as illustrated in FIG. 13C, ranging point 2 exists in the position corresponding to the distance 3/2 times the distance to ranging point 1, and thus, the first multiple reflection flag is configured to be 1.

Thereafter, in a case where the second ultrasound transmission is performed at time T+1 after a certain time has elapsed from time T and it is determined that ranging point 2 exists in the position corresponding to the distance 3/2 times the distance to ranging point 1, target processing circuitry 22 decides the position of an object at a short distance since the first multiple reflection flag has been already configured to be 1.

For this reason, in a case where the first multiple reflection flag is 1 in step S61 illustrated in FIG. 13A (step 61, YES), target processing circuitry 22 determines in step S62 that an object exists in the position (ranging point 0) corresponding to the distance ½ times the distance from ultrasonic sensor 10 to ranging point 1, and performs ranging by assuming that ranging points 1 and 2 involve multiple reflection due to the object.

A case where the first multiple reflection flag is 0 (step 61, NO) means that ranging point 2 has not existed in the position corresponding to the distance 3/2 times the distance to ranging point 1 in the first ultrasound transmission.

For this reason, in step S63, target processing circuitry 22 configures the first multiple reflection flag to be 1, but does not perform ranging of an object.

Note that, in the processing example illustrated in FIGS. 13A and 13B, an example in which, in a case where two consecutive wave transmissions are performed, ranging is performed when an object at a short distance can be detected in each of the wave transmissions has been described, but the number of wave transmissions by sensor system 200 may be three times or more. Further, even in a case where it is difficult to detect short-distance objects consecutively, sensor system 200 may detect objects at a short-distance based on results of a plurality of times of wave transmission.

### Other Configuration Example 3 of Sensor System 200

Sensor system 200 may also be configured to improve the reliability of detecting an object that exists at a short distance by changing patterns of the number of pulses in wave transmission.

Specifically, in a case where sensor system 200 performs a first wave transmission with a predetermined number of pulses and then determines by short-distance detection processing that an object exists at a short distance, sensor system 200 increases or decreases, in a second wave transmission, the number of pulses at the time of the last wave transmission.

Then, sensor system 200 performs short-distance detection processing after the second wave transmission to determine whether an object detected at the time of the first wave transmission can be detected again at the time of the second wave transmission, thereby improving the reliability of detecting an object that exists at a short distance.

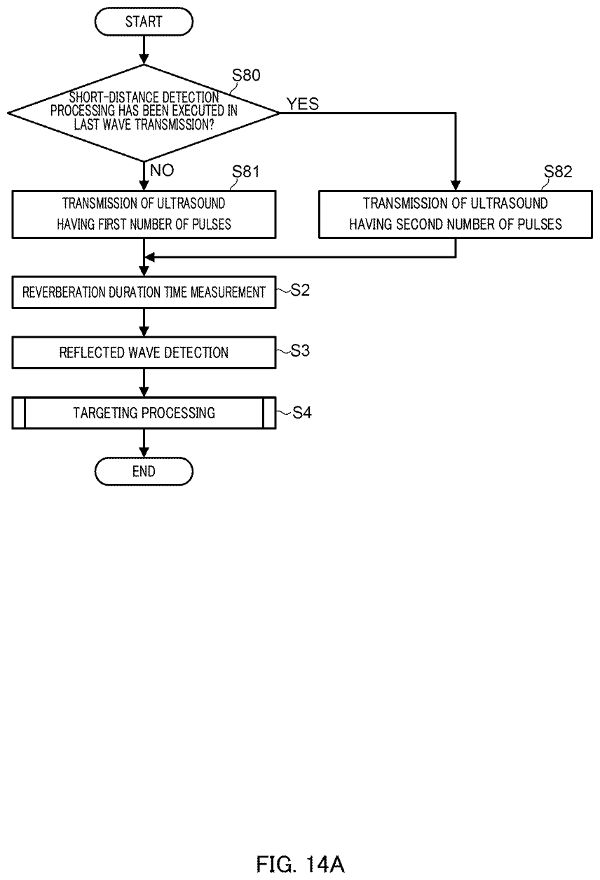

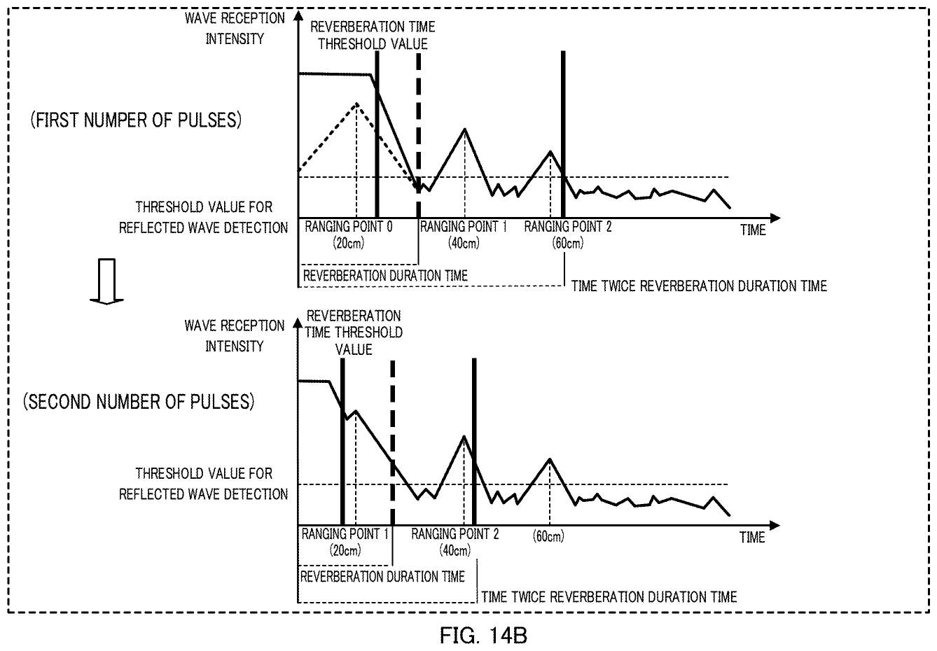

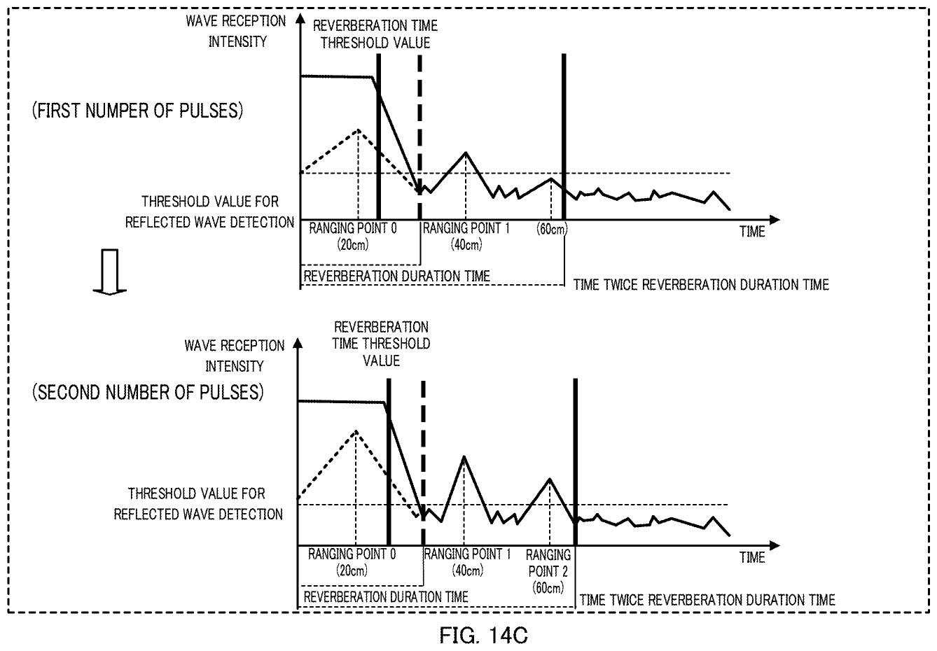

Operations of sensor system 200 according to other configuration example 3 will be described with reference to FIGS. 14A, 14B, and 14C.

In step S80 illustrated in FIG. 14A, determination is executed as to whether short-distance detection processing has been executed at the time of the last wave transmission.

In a case where the short-distance detection processing has not been executed (step S80, NO), ultrasonic sensor 10 transmits ultrasound having a first number of pulses in step S81. Then, the processing in step S2 and thereafter is executed.

Step S80 will be described again. In a case where the short-distance detection processing has been performed (step S80, YES), ultrasonic sensor 10 transmits, in step S82, ultrasound having a second number of pulses, which differs from the first number of pulses at the time of the last wave transmission. Then, the processing in step S2 and thereafter is executed.

In each of FIGS. 14B and 14C, the vertical axis represents wave reception intensity and the horizontal axis represents time.

As illustrated in FIG. 14B, in a case where the ultrasound having the first number of pulses has been transmitted and then the transmission of the ultrasound having the second number of pulses, which is less than the first number of pulses, is executed, it is possible to detect an object that exists in a position (ranging point 0) in which the object is difficult to detect by the ultrasound having the first number of pulses.

As illustrated in FIG. 14C, in a case where the ultrasound having the first number of pulses has been transmitted and then the transmission of the ultrasound having the second number of pulses, which is greater than the first number of pulses, is executed, the wave reception intensity of a multiple reflected wave increases. For this reason, for example, the wave reception intensity at ranging point 2 becomes higher than the threshold value for reflected wave detection, and thus, it is possible to detect ranging point 2 that exists at a distance 3/2 times the distance to the position of ranging point 1.

Note that, in the processing example illustrated in FIG. 14A, a case where two types of ultrasound having different numbers of pulses are transmitted has been described, but the types of ultrasound having different numbers of pulses may also be three or more. Further, sensor system 200 may consecutively transmit ultrasound having different numbers of pulses even in a case where no object at a short distance is detected.

As described above, an object detection apparatus according to the embodiment of the present disclosure is configured to include: measurement circuitry, which, in operation, measures a first local maximum point of a first reflected wave of an acoustic wave and a second local maximum point of a second reflected wave of the acoustic wave, where the acoustic wave is emitted from an ultrasonic sensor provided in a vehicle and the second reflected wave is a reflected wave following the first reflected wave; and target processing circuitry, which, in operation, performs ranging of an object by assuming that the object exists in a position within a predetermined error range of a distance ½ times a distance from the ultrasonic sensor to a position corresponding to the first local maximum point, in a case where the position corresponding to the first local maximum point is closer than a distance within a predetermined error range of a distance twice a reverberation distance corresponding to a reverberation duration time of the ultrasonic sensor and farther than a distance within a predetermined error range of the reverberation distance and in a case where a position corresponding to the second local maximum point is a position within a predetermined error range of a distance 3/2 times the distance from the ultrasonic sensor to the position corresponding to the first local maximum point.

With this configuration, it is possible to perform, based on ranging points that are the respective local maximum points of two reflected waves, ranging of an object which exists at such a short distance that a reflected wave and reverberation are superposed on each other.

Further, according to the object detection apparatus according to the embodiment of the present disclosure, it is possible to perform ranging of an object which exists at such a short distance that a reflected wave and reverberation are superposed on each other, not only in a case where the vehicle is traveling, but also in a case where the vehicle stops.

Note that, it is understood that, for example, the following aspects also belong to the technical scope of the present disclosure.
(1) An object detection apparatus according to an embodiment of the present disclosure includes: measurement circuitry, which, in operation, measures a first local maximum point of a first reflected wave of an acoustic wave and a second local maximum point of a second reflected wave of the acoustic wave, where the acoustic wave is emitted from an ultrasonic sensor provided in a vehicle and the second reflected wave is a reflected wave following the first reflected wave; and target processing circuitry, which, in operation, performs ranging of an object by assuming that the object exists in a position within a predetermined error range of a distance ½ times a distance from the ultrasonic sensor to a position corresponding to the first local maximum point, in a case where the position corresponding to the first local maximum point is closer than a distance within a predetermined error range of a distance twice a reverberation distance corresponding to a reverberation duration time of the ultrasonic sensor and farther than a distance within a predetermined error range of the reverberation distance and in a case where a position corresponding to the second local maximum point is a position within a predetermined error range of a distance 3/2 times the distance from the ultrasonic sensor to the position corresponding to the first local maximum point.
(2) In a case where the position corresponding to the second local maximum point is not the position within the predetermined error range of the distance 3/2 times the distance from the ultrasonic sensor to the position corresponding to the first local maximum point and in a case where the second local maximum point exists in a position within a predetermined error range of a distance twice the distance from the ultrasonic sensor to the position corresponding to the first local maximum point, the target processing circuitry performs the ranging of the object by assuming that the object exists in the position corresponding to the first local maximum point. In a case where the position corresponding to the second local maximum point is not the position within the predetermined error range of the distance 3/2 times the distance from the ultrasonic sensor to the position corresponding to the first local maximum point and in a case where the second local maximum point does not exist in the position within the predetermined error range of the distance twice the distance from the ultrasonic sensor to the position corresponding to the first local maximum point, the target processing circuitry does not perform the ranging of the object by assuming that the object does not exist in the position corresponding to the first local maximum point.
(3) The object detection apparatus according to an embodiment of the present disclosure further includes reverberation threshold value calculation circuitry, which, in operation, calculates, each time the acoustic wave is emitted, a reverberation time threshold value and changes, according to at least one of the reverberation duration time and/or a number of pulses of the acoustic wave, a length of the reverberation time threshold value having been calculated, where the reverberation time threshold value defining a time during which a saturation state of reverberation of the ultrasonic sensor continues. In a case where the position corresponding to the first local maximum point is farther than a position corresponding to the reverberation time threshold value having been changed, the target processing circuitry performs the ranging of the object.
(4) In a case where the position corresponding to the second local maximum point is the position within the predetermined error range of the distance 3/2 times the distance from the ultrasonic sensor to the position corresponding to the first local maximum point and in a case where the target processing circuitry determines that a wave reception intensity at the first local maximum point is greater than a wave reception intensity at the second local maximum point, the target processing circuitry performs ranging of an object that exists in a position within a predetermined error range of a distance ½ times the distance from the ultrasonic sensor to the position corresponding to the first local maximum point.
(5) The target processing circuitry performs the ranging of the object based on a first local maximum point of the first reflected wave and a second local maximum point of the second reflected wave, where the first local maximum point and the second local maximum point are measured for each of acoustic waves having been emitted a plurality of times from the ultrasonic sensor.
(6) For each of the acoustic waves having been emitted the plurality of times, the target processing circuitry performs the ranging of the object in a case where the position corresponding to the second local maximum point is the position within the predetermined error range of the distance 3/2 times the distance from the ultrasonic sensor to the position corresponding to the first local maximum point.
(7) The target processing circuitry performs the ranging of the object based on a first local maximum point of the first reflected wave and a second local maximum point of the second reflected wave, where the first local maximum point and the second local maximum point are measured for each of acoustic waves having been emitted a plurality of times from the ultrasonic sensor and having different numbers of pulses.
(8) The acoustic waves having been emitted the plurality of times from the ultrasonic sensor include an acoustic wave having a first number of pulses and an acoustic wave having a second number of pulses, where the second number of pulses is greater than the first number of pulses.
(9) In a case where the target processing circuitry has performed the ranging of the object a last time based on the first local maximum point of the first reflected wave and the second local maximum point of the second reflected wave that have been measured with respect to the acoustic wave having the first number of pulses, the target processing circuitry performs the ranging of the object based on the first local maximum point of the first reflected wave and the second local maximum point of the second reflected wave that are measured with respect to the acoustic wave having the second number of pulses.
(10) The acoustic waves having been emitted the plurality of times from the ultrasonic sensor include an acoustic wave having a first number of pulses and an acoustic wave having a second number of pulses, where the second number of pulses is less than the first number of pulses.
(11) In a case where the target processing circuitry has performed the ranging of the object a last time based on the first local maximum point of the first reflected wave and the second local maximum point of the second reflected wave that have been measured with respect to the acoustic wave having the first number of pulses, the target processing circuitry performs the ranging of the object based on the first local maximum point of the first reflected wave and the second local maximum point of the second reflected wave that are measured with respect to the acoustic wave having the second number of pulses.
(12) In a case where a wave reception intensity corresponding to the first local maximum point is greater than a wave reception intensity corresponding to the second local maximum point, the target processing circuitry performs the ranging of the object. In a case where the wave reception intensity corresponding to the first local maximum point is less than the wave reception intensity corresponding to the second local maximum point, the target processing circuitry performs the ranging of the object, and performs ranging by assuming that another object other than the object exists in the position corresponding to the second local maximum point.
(13) A sensor system includes: the object detection apparatus described above; and the ultrasonic sensor.
(14) A vehicle includes the sensor system described above.
(15) An object detection method according to an embodiment of the present disclosure includes: measuring a first local maximum point of a first reflected wave of an acoustic wave and a second local maximum point of a second reflected wave of the acoustic wave, where the acoustic wave is emitted from an ultrasonic sensor provided in a vehicle and the second reflected wave is a reflected wave following the first reflected wave; and performing ranging of an object by assuming that the object exists in a position within a predetermined error range of a distance ½ times a distance from the ultrasonic sensor to a position corresponding to the first local maximum point, in a case where the position corresponding to the first local maximum point is closer than a distance within a predetermined error range of a distance twice a reverberation distance corresponding to a reverberation duration time of the ultrasonic sensor and farther than a distance within a predetermined error range of the reverberation distance and in a case where a position corresponding to the second local maximum point is a position within a predetermined error range of a distance 3/2 times the distance from the ultrasonic sensor to the position corresponding to the first local maximum point.

Various embodiments have been described above with reference to the accompanying drawings. It goes without saying, however, that the present disclosure is not limited to such examples. It is obvious that a person skilled in the art can conceive various alteration examples and correction examples within the scope described in the present disclosure. It is naturally understood that these alteration examples and correction examples also belong to the technical scope of the present disclosure. Further, various components in each embodiment described above may be arbitrarily combined without departing from the spirit of the present disclosure.

Specific examples of the present disclosure have been described in detail above, but these specific examples are mere exemplifications and do not limit the scope of the claims. The technology described in the scope of the claims may include various modifications and changes made to the specific examples exemplified in the present disclosure.

The expressions “ . . . processor”, “ . . . -er”, “ . . . -or”, and “ . . . -ar” in each embodiment described above may be replaced with other expressions such as “ . . . circuitry”, “. . . assembly”, “ . . . device”, “ . . . unit”, or “ . . . module”.

Although each embodiment has been described above with reference to the accompanying drawings, the present disclosure is not limited to such an example. It is obvious that a person skilled in the art can conceive various alteration examples and correction examples within the scope described in the claims. It is understood that such alteration examples and correction examples also belong to the technical scope of the present disclosure. Further, various components in each embodiment may be arbitrarily combined without departing from the spirit of the present disclosure.

The present disclosure can be realized by software, hardware, or software in cooperation with hardware.

Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a field programmable gate array (FPGA) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The disclosure of Japanese Patent Application No. 2021-055814, filed on Mar. 29, 2021, including the specification, drawings and abstract, is incorporated herein by reference in its entirety.

### INDUSTRIAL APPLICABILITY

An embodiment of the present disclosure is suitable for an object detection apparatus and an object detection method.

1. An object detection apparatus, comprising:
measurement circuitry, which, in operation, measures a first local maximum point of a first reflected wave of an acoustic wave and a second local maximum point of a second reflected wave of the acoustic wave, the acoustic wave being emitted from an ultrasonic sensor provided in a vehicle, the second reflected wave being a reflected wave following the first reflected wave; and
target processing circuitry, which, in operation, performs ranging of an object by assuming that the object exists in a position within a predetermined error range of a distance ½ times a distance from the ultrasonic sensor to a position corresponding to the first local maximum point, in a case where the position corresponding to the first local maximum point is closer than a distance within a predetermined error range of a distance twice a reverberation distance and farther than a distance within a predetermined error range of the reverberation distance and in a case where a position corresponding to the second local maximum point is a position within a predetermined error range of a distance 3/2 times the distance from the ultrasonic sensor to the position corresponding to the first local maximum point, the reverberation distance corresponding to a reverberation duration time of the ultrasonic sensor.

2. The object detection apparatus according to claim 1, wherein
in a case where the position corresponding to the second local maximum point is not the position within the predetermined error range of the distance 3/2 times the distance from the ultrasonic sensor to the position corresponding to the first local maximum point and in a case where the second local maximum point exists in a position within a predetermined error range of a distance twice the distance from the ultrasonic sensor to the position corresponding to the first local maximum point, the target processing circuitry performs the ranging of the object by assuming that the object exists in the position corresponding to the first local maximum point, and
in a case where the position corresponding to the second local maximum point is not the position within the predetermined error range of the distance 3/2 times the distance from the ultrasonic sensor to the position corresponding to the first local maximum point and in a case where the second local maximum point does not exist in the position within the predetermined error range of the distance twice the distance from the ultrasonic sensor to the position corresponding to the first local maximum point, the target processing circuitry does not perform the ranging of the object by assuming that the object does not exist in the position corresponding to the first local maximum point.

3. The object detection apparatus according to claim 1, further comprising reverberation threshold value calculation circuitry, which, in operation, calculates, each time the acoustic wave is emitted, a reverberation time threshold value and changes, according to at least one of the reverberation duration time and/or a number of pulses of the acoustic wave, a length of the reverberation time threshold value having been calculated, the reverberation time threshold value defining a time during which a saturation state of reverberation of the ultrasonic sensor continues, wherein
in a case where the position corresponding to the first local maximum point is farther than a position corresponding to the reverberation time threshold value having been changed, the target processing circuitry performs the ranging of the object.

4. The object detection apparatus according to claim 1, wherein in a case where the position corresponding to the second local maximum point is the position within the predetermined error range of the distance 3/2 times the distance from the ultrasonic sensor to the position corresponding to the first local maximum point and in a case where the target processing circuitry determines that a wave reception intensity at the first local maximum point is greater than a wave reception intensity at the second local maximum point, the target processing circuitry performs ranging of an object that exists in a position within a predetermined error range of a distance ½ times the distance from the ultrasonic sensor to the position corresponding to the first local maximum point.

5. The object detection apparatus according to claim 1, wherein the target processing circuitry performs the ranging of the object based on a first local maximum point of the first reflected wave and a second local maximum point of the second reflected wave, the first local maximum point and the second local maximum point being measured for each of acoustic waves having been emitted a plurality of times from the ultrasonic sensor.

6. The object detection apparatus according to claim 5, wherein for each of the acoustic waves having been emitted the plurality of times, the target processing circuitry performs the ranging of the object in a case where the position corresponding to the second local maximum point is the position within the predetermined error range of the distance 3/2 times the distance from the ultrasonic sensor to the position corresponding to the first local maximum point.

7. The object detection apparatus according to claim 1, wherein the target processing circuitry performs the ranging of the object based on a first local maximum point of the first reflected wave and a second local maximum point of the second reflected wave, the first local maximum point and the second local maximum point being measured for each of acoustic waves having been emitted a plurality of times from the ultrasonic sensor and having different numbers of pulses.

8. The object detection apparatus according to claim 7, wherein the acoustic waves having been emitted the plurality of times from the ultrasonic sensor include an acoustic wave having a first number of pulses and an acoustic wave having a second number of pulses, the second number of pulses being greater than the first number of pulses.

9. The object detection apparatus according to claim 8, wherein in a case where the target processing circuitry has performed the ranging of the object a last time based on the first local maximum point of the first reflected wave and the second local maximum point of the second reflected wave that have been measured with respect to the acoustic wave having the first number of pulses, the target processing circuitry performs the ranging of the object based on the first local maximum point of the first reflected wave and the second local maximum point of the second reflected wave that are measured with respect to the acoustic wave having the second number of pulses.

10. The object detection apparatus according to claim 7, wherein the acoustic waves having been emitted the plurality of times from the ultrasonic sensor include an acoustic wave having a first number of pulses and an acoustic wave having a second number of pulses, the second number of pulses being less than the first number of pulses.

11. The object detection apparatus according to claim 10, wherein in a case where the target processing circuitry has performed the ranging of the object a last time based on the first local maximum point of the first reflected wave and the second local maximum point of the second reflected wave that have been measured with respect to the acoustic wave having the first number of pulses, the target processing circuitry performs the ranging of the object based on the first local maximum point of the first reflected wave and the second local maximum point of the second reflected wave that are measured with respect to the acoustic wave having the second number of pulses.

12. The object detection apparatus according to claim 1, wherein:
in a case where a wave reception intensity corresponding to the first local maximum point is greater than a wave reception intensity corresponding to the second local maximum point, the target processing circuitry performs the ranging of the object, and
in a case where the wave reception intensity corresponding to the first local maximum point is less than the wave reception intensity corresponding to the second local maximum point, the target processing circuitry performs the ranging of the object, and performs ranging by assuming that another object other than the object exists in the position corresponding to the second local maximum point.

13. A sensor system, comprising:
the object detection apparatus according to claim 1; and
the ultrasonic sensor.

14. A vehicle, comprising the sensor system according to claim 13.

15. An object detection method, comprising:
measuring a first local maximum point of a first reflected wave of an acoustic wave and a second local maximum point of a second reflected wave of the acoustic wave, the acoustic wave being emitted from an ultrasonic sensor provided in a vehicle, the second reflected wave being a reflected wave following the first reflected wave; and
performing ranging of an object by assuming that the object exists in a position within a predetermined error range of a distance ½ times a distance from the ultrasonic sensor to a position corresponding to the first local maximum point, in a case where the position corresponding to the first local maximum point is closer than a distance within a predetermined error range of a distance twice a reverberation distance and farther than a distance within a predetermined error range of the reverberation distance and in a case where a position corresponding to the second local maximum point is a position within a predetermined error range of a distance 3/2 times the distance from the ultrasonic sensor to the position corresponding to the first local maximum point, the reverberation distance corresponding to a reverberation duration time of the ultrasonic sensor.
